(19) United States
(12) Patent Application Publication
(10) Pub. No.: US 2026/0321028 A1
(43) Pub. Date: Oct. 15, 2026

(54) Method and System for Identifying an Interior Space Configuration of a Vehicle

(71) Applicant: Bayerische Motoren Werke Aktiengesellschaft, Muenchen (DE)

(72) Inventors: Thomas Ewender, Muenchen (DE); Florian Ober, Reichersbeuern (DE)

(21) Appl. No.: 18/996,926

(22) PCT Filed: May 12, 2023
(86) PCT No.: PCT/EP2023/062742

§ 371 Date: Jan. 17, 2025

(30) Foreign Application Priority Data
Aug. 26, 2022 (DE) 10 2022 121 614.4

(51) Int. Cl. G06V 20/59; G06T 7/73; G06T 7/80

(52) U.S. Cl. CPC G06V 20/59; G06T 7/73; G06T 7/80; G06T 2207/10048; G06T 2207/30242; G06T 2207/30268

(57) ABSTRACT

A method identifies a configuration of an interior space of a vehicle. The method includes capturing image data using at least one image capture device, wherein the image data represents a view of the interior space of the vehicle, wherein the view at least partially contains at least one fixed part of the vehicle and at least one movable component of the interior space of the vehicle. The method also includes performing an evaluation of the image data. The evaluation includes identifying the at least one fixed part of the vehicle, in order to assign the view to a corresponding area of the interior space of the vehicle. The evaluation also includes identifying a configuration of the at least one movable component of the interior space in the area of the interior space of the vehicle that is assigned to the view.

The present application is the U.S. national phase of PCT Application PCT/EP2023/062742 filed on May 12, 2023, which claims priority of German patent application No. 10 2022 121 614.4 filed on Aug. 26, 2022, the entire contents of which are incorporated herein by reference.

### TECHNICAL FIELD

The present disclosure relates to vehicles, and more specifically, to identifying a configuration of an interior space of a vehicle.

### BACKGROUND

It can be necessary or desirable in various situations in a vehicle to define a configuration of the interior space. In particular, the seats of a vehicle can be adjusted, the seatbacks can be adjusted to the rear or tables or other movable components can be folded out or extended. With the implementation of level 3 to level 5 driver assistance functions (in particular at level 4 or level 5), further variations of seat settings can also be possible during the journey, for example, the seats could be rotated toward the vehicle interior. Because of this, specific airbags have to be triggered or suppressed depending on the configuration of the interior space components. For example, the front airbag has to be deactivated when the front seats are rotated. When the seatback is reclined, for example, a different airbag has to be activated than with an upright seatback setting. The identification of this vehicle interior space configuration typically requires a sensor in each movable interior space component, such as a position sensor (for example, Hall sensor or potentiometer), in order to identify the position of the interior space components, and also engagement of components (for example, upon seat rotation, folding over of backrests, etc.).

An identification of changes in the interior space of a vehicle, for example, also an identification of seat occupancies can be carried out in a camera-based manner. In many different technical applications, the object arises of analyzing image data, thus data which represent an image or a sequence of images, such as a video, as to whether and possibly which objects are depicted in the image or images. The identification of movements or changes of such objects on the basis of such images or image data is also regularly of interest. Corresponding cameras can be installed fixedly in the interior space of a vehicle for this purpose, in order to capture a defined view of the interior space. Corresponding image data can then be evaluated. A camera can be provided, for example, in the dashboard, where parts of the interior space can be concealed by parts of the vehicle or vehicle occupants, however. Visible cameras attached in the interior space of a vehicle are often not desired by the customer, however.

There is a need, therefore, for further improving the identification of a configuration of an interior space of a vehicle. In particular, there is a need for identification to take place without special sensors in the individual movable components in the interior space of the vehicle.

### SUMMARY

At least some embodiments address the above needs, as well as others, by carrying out the recognition of the interior space configuration based on image data which is captured by means of an image capture device, such as a camera, in the interior space of the vehicle.

A first aspect relates to a method for identifying a configuration of an interior space of a vehicle. In the method, image data are captured by means of at least one image capture device, wherein the image data represent a view of the interior space of the vehicle, wherein the view at least partially contains in each case at least one fixed part of the vehicle and at least one movable component of the interior space of the vehicle. The image data are evaluated. The at least one fixed part of the vehicle is identified here in order to assign the view to a corresponding area of the interior space of the vehicle. In addition, a configuration of the at least one movable component of the interior space in the area of the interior space of the vehicle that is assigned to the view is identified.

The above-mentioned method according to the first aspect is therefore in particular based on image data being evaluated which are captured by means of an image capture device, such as camera. The image capture device records a view of the interior space, from which a configuration of a movable component in the interior space can be identified. A reliable identification of the configuration of the movable component can be achieved in that a fixed part of the vehicle is also identified. The image evaluation can orient itself on the fixed part of the vehicle.

Upon the evaluation of the image data, the view recorded by the image capture device is used, wherein the configuration of the individual components can be identified, for example, using machine learning or a classic image identification approach. The method can make use here of fixed parts of the vehicle and therefore unchangeable parts and conclude the configuration of the movable component(s). No special sensors (such as Hall sensors) are required in the interior space or in the individual movable components of the interior space, for example, in the seats. Since the method incorporates fixed parts of the vehicle, for example, no extra measurement markings are required on the movable components in the interior space or elsewhere in the interior space of the vehicle either.

The term “vehicle” used here refers in particular to a passenger vehicle, including all types of motor vehicles, hybrid electric vehicles and battery-operated electric vehicles, as well as vehicles such as vans, buses, trucks, delivery vans, and the like.

The term “configuration of an interior space of a vehicle” (equivalent to “interior space configuration of a vehicle”, “configuration of a vehicle interior space”, or “vehicle interior space configuration”), as used herein, is to be understood in particular as an arrangement of interior space components, in particular including their position and orientation in space, i.e. in a vehicle coordinate system. This can in particular include their absolute position and/or orientation in space and their relative position and/or orientation with respect to other components of the vehicle or the vehicle interior space. The term can include the configuration of a single component and also a plurality of components.

The term “image capture device” used here refers in particular to a camera, in particular a digital camera. The camera can record still images (photographs) or images (videos). The image capture device can capture or record such an image and output corresponding image data.

The term “view”, as used herein, refers in particular to a field of view of the image capture device. In other words, the view shows that area of the vehicle interior space which can be recorded by means of the image capture device. The view can change, for example, when the image capture device is moved. The view is assigned to an area of the interior space of the vehicle, namely that area which is visible in the view. The view can be two-dimensional or three-dimensional.

The term “fixed part (of the vehicle)”, as used herein, refers in particular to those parts of the vehicles which cannot be changed or moved. These can be, for example, parts of the body of the vehicle, such as the A-pillar or B-pillar of the vehicle. Parts of the interior space can also be fixed, such as the center console or also fixed structures or elements on the floor or the interior trim.

The term “movable component (of the interior space of the vehicle) ”, as used herein, refers in particular to components of the interior space which can be moved in the interior space in particular by operation or actuation (manual or automatic), i.e. their position and/or orientation in space is changeable, in particular relative to fixed parts of the vehicle. This can also include changes relating to the shape of the component.

The terms “comprises”, “contains”, “incorporates”, “includes”, “has”, “with” optionally used herein, or any other variant thereof are to cover a non-exhaustive inclusion. Thus, for example, a method or a device which comprises or has a list of elements is not necessarily restricted to these elements, but rather can include other elements which are not expressly listed or which are inherent to such a method or such a device.

Furthermore, “or”, if not expressly indicated to the contrary, refers inclusive or and not to an exclusive “or”. For example, a condition A or B is met by one of the following conditions: A is true (or present) and B is false (or not present), A is false (or not present) and B is true (or present), and both A and B are true (or present).

The terms “a” or “an”, as used here, are defined in the meaning of “a/one or multiple”. The terms “another” and “a further” and any other variant thereof are to be understood in the meaning of “at least one further”.

The term “plurality”, as used here, is to be understood in the meaning of “two or more”.

The term “configured” or “set up” to fulfill a specific function (and respective modifications thereof) is to be understood in the meaning of the disclosure to mean that the corresponding device is already present in a design or setting in which it can execute the function or it is at least settable-i.e. configurable-so that it can execute the function after corresponding setting. The configuration can take place here, for example, via a corresponding setting of parameters of a process sequence or of switches or the like for activating or deactivating functionalities or settings. In particular, the device can include multiple predetermined configurations or operating modes, so that the configuring can be carried out by means of a selection of one of these configurations or operating modes.

Preferred embodiments of the method are described hereinafter, which can each, if not expressly excluded or technically impossible, be combined with one another as desired and with the further described other aspects.

In some embodiments, the identified configuration of the at least one movable component comprises an absolute position and orientation of the movable component in the area of the interior space of the vehicle that is assigned to the view with respect to a three-dimensional coordinate system. In other words, a movable component can be defined in the vehicle interior space with respect to six degrees of freedom. This comprises shifts along three axes, for example, an x, and z axis in an orthogonal coordinate system, such as a vehicle coordinate system, and rotations around these three axes. An accurate identification of the configuration of the movable component can thus be provided.

In some embodiments, the identified configuration of the at least one movable component comprises a relative position and orientation of the movable component with respect to at least one fixed part of the vehicle. An advantageous identification of the configuration of the movable component can be provided if the configuration is identified relative to fixed parts of the vehicle. For example, it can thus be established how far away an inclined seatback is from a (closed) door, an interior trim, or the dashboard of the vehicle.

In some embodiments, the movable component comprises at least one seat of the vehicle, wherein the identified configuration comprises at least one of a seat position, seat rotation, and an inclination (or an inclination angle) of a backrest of the seat. The seat of a vehicle can typically be adjusted. This relates in particular to the driver seat and the front passenger seat. For example, a seat can be displaceable and adjustable in height. The seatback can also be adjusted. In the context of autonomous driving, it can also be possible to rotate or pivot the seats, in particular the driver seat and front passenger seat, so that they face in the direction of the vehicle center or opposite to the direction of travel. The identification of such a configuration can be important for certain vehicle functions, as explained in more detail below. It can also be of interest to recognize whether the backrest of a back seat is folded over, whether entirely or partially. Like the front seats, in some vehicles the backseats can also be adjustable accordingly.

In some embodiments, the movable component comprises at least one accessory part of the vehicle, wherein the identified configuration comprises a position and/or orientation of the accessory part in the interior space of the vehicle. In addition to the seats, further components in the interior space can also be movable, which can also be relevant for the control of a vehicle function, for example, if the movable accessory component can be in the way for a specific vehicle function. These can be, for example, accessory parts of seats, such as an armrest of a seat or a movable foot support, a pivotable or foldable table, a pivotable or foldable display, or other movable accessory parts.

In some embodiments, a calibration of the image capture device is carried out by the identification of the at least one fixed part. This is advantageous in particular if the image capture device is movable and does not have a dedicated position sensor. An (auto) calibration can then be carried out easily on the basis of the image which the image capture device records, since the configuration of the fixed parts of the vehicle is unchangeable and known, for example, the position, orientation, shape, and the like.

In some embodiments, a position and/or orientation of the image capture device in the interior space of the vehicle is determined by the identification of the at least one fixed part. This can also be used for calibration. For example, a neutral position of the image capture device can thus be determined in a simple manner in order to facilitate the identification of the configuration of the movable components in the vehicle interior space.

In some embodiments, the method comprises a comparison of the image data with (three-dimensional) design data of the vehicle, in particular of the interior space of the vehicle. These can be, for example, CAD data of the vehicle. These data are known and can represent a three-dimensional model of the vehicle. By comparing this known model of the vehicle with the image data, fixed parts of the vehicle and also movable components can be identified in a simple manner, even if they are not completely contained in the view, for example. In the case of the movable components, it can be taken into consideration in particular that they are not arbitrarily movable, but rather only in a predetermined range. For example, a seat typically cannot be displaced arbitrarily, but rather only over a certain distance. A seatback can also typically only be moved in a specific angle range. This can be inferred from such design data.

In some embodiments, at least one signal source is actuated depending on the identified configuration of the at least one movable component, in order to prompt the signal source to output a defined signal depending on the actuation. A vehicle function can thus be executed, activated, or deactivated. For example, it can be determined depending on the configuration of the at least one movable component whether a specific airbag is triggered or suppressed in the case of a crash. For example, a driver airbag can be deactivated when the driver seat is rotated. It can also be possible to deactivate a specific airbag if a display is folded out, for example, so that it enters the trigger area of the airbag. Vice versa, such an airbag can be activated when the display is folded in again. A further example can be the control of a vehicle ventilation, which takes place depending on the configuration of the seats.

In some embodiments, the view at least partially contains each of multiple movable components of the interior space of the vehicle, wherein a configuration of all of the movable components contained in the view is identified. The movable components can be entirely or also only partially contained in the view here. In this way, it is possible to react comprehensively to multiple changes of the configuration of movable components in the interior space. Preferably, the view contains all movable components (each at least partially) which are relevant for a specific vehicle function, for example, for the actuation of airbags. An overall configuration of the vehicle interior space can thus be identified easily without further sensors being required.

A second aspect relates to a system for data processing, comprising at least one processor configured so that it carries out the method according to the first aspect. The system furthermore comprises at least one image capture device, which is attached in an interior space of a vehicle and is configured to capture a view of the interior space of the vehicle.

In some embodiments, the image capture device is arranged in a movable component of the interior space of the vehicle. This permits a flexible design of the interior space. The image capture device does not have to be arranged in a fixed position. In particular due to the image evaluation as described above, a configuration of a movable component in the vehicle interior space can also be reliably recognized when the image capture device is movable.

In some embodiments, the image capture device is arranged in an interior mirror of the vehicle. The arrangement in the interior mirror is advantageous since a good overview of the interior space (from the front top) can thus be achieved. In particular, the field of view is not concealed, for example, by the steering wheel or vehicle occupants, as it would be if the image capture device were arranged in the dashboard, for example. The image capture device can thus also be arranged in a concealed manner and is not disturbing to the vehicle occupants. The method can nonetheless be carried out reliably if the interior mirror is moved, as explained above.

In some embodiments, the image capture device is a 2D camera or a 3D camera. A two-dimensional or three-dimensional view, respectively, is captured accordingly. It can in particular be an infrared camera or a time-of-flight camera (TOF camera). For an infrared camera (IR or NIR), a corresponding infrared light source can be provided, so that the method can also be carried out reliably in darkness. If a TOF camera is used, by means of a light time-of-flight method, a three-dimensional view of the interior space can in particular be captured by means of a PMD sensor. Changes of the configuration of the interior space can thus be captured, for example, by determining distances in an accurate manner. It is obvious that the image capture device can also be a camera which operates with visible light (daylight), in particular in the RGB color space. The image capture device can in particular be a wide-angle camera in order to obtain the largest possible area of the interior space as a view.

A third aspect relates to a computer program having instructions which, when they are executed on a system according to the second aspect, prompt it to carry out the method according to the first aspect.

The computer program can in particular be stored on a nonvolatile data carrier. This is preferably a data carrier in the form of an optical data carrier or a flash memory module. This can be advantageous if the computer program as such is to be handled independently of a processor platform on which the one or the multiple programs are to be executed. In another implementation, the computer program can be present as a file on a data processing unit, in particular on a server, and can be downloadable via a data connection, for example, the Internet or a dedicated data connection, such as a proprietary or local network. Moreover, the computer program can comprise a plurality of interacting individual program modules.

The system according to the second aspect can accordingly comprise a program memory in which the computer program is stored. Alternatively, the system can also be configured to access an external computer program, for example, available on one or more servers or other data processing units, via a communication connection, in particular to exchange data therewith, which are used during the sequence of the method or computer program or represent outputs of the computer program.

The above-described features and advantages, as well as others, will become more readily apparent to those of ordinary skill in the art with reference to following detailed description and accompanying drawings. Features of the first aspect also apply accordingly to the further aspects. This likewise applies for the features and advantages explained with reference to the second aspect.

### BRIEF DESCRIPTION OF THE DRAWINGS

FIG. 1 shows a flow chart of a method according to one embodiment; and

FIG. 2 shows a view of a vehicle interior space.

### DETAILED DESCRIPTION

In the figures, the same reference signs are used throughout for the same or mutually corresponding elements of the invention.

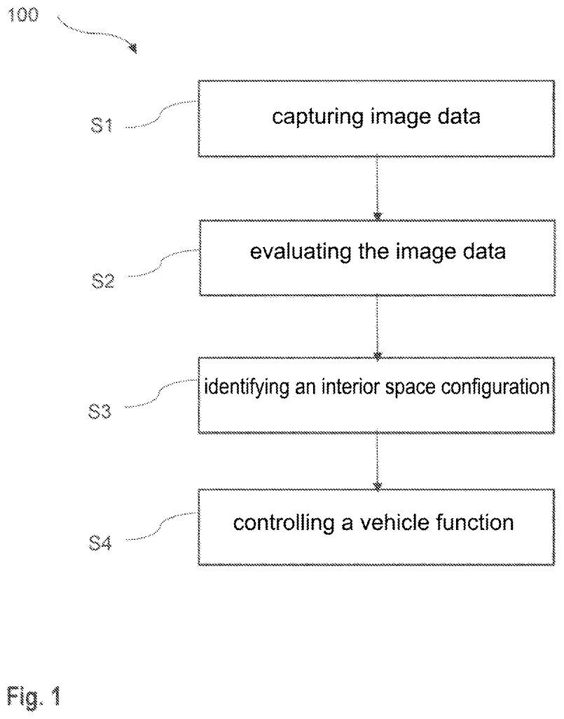

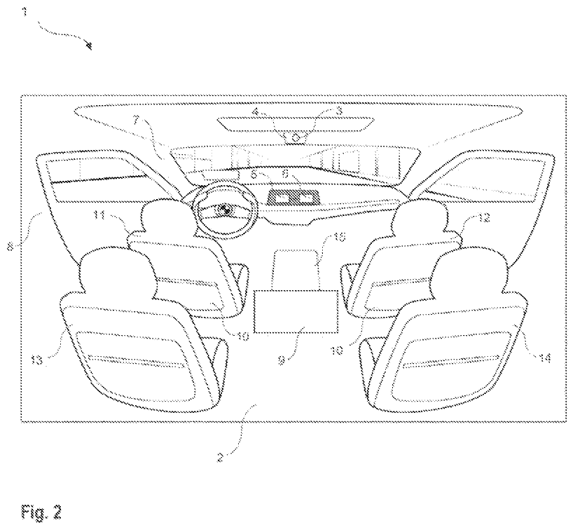

FIG. 1 illustrates a method 100 for identifying a configuration of an interior space of a vehicle. FIG. 2 shows by way of example a vehicle interior space 2 having four seats 11, 12, 13, 14. The method is carried out in a data processing system of the vehicle 1, which can comprise a corresponding processor 5 (for example, ECU) and a memory 6 (schematically indicated in FIG. 2).

In a step S1, initially a view of the interior space 2 is recorded using a camera 3 and corresponding image data are captured for further processing by the system. The camera can be an infrared camera having a corresponding infrared light source, which enables the execution in darkness. The camera 3 can also be a 3D camera, such as a TOF camera, which supplies a three-dimensional view of the vehicle interior space 2.

The camera 3 can be arranged in an interior mirror 4 of the vehicle 1. The camera 3 can thus be arranged discreetly in the interior space 2. Since the interior mirror 4 is typically movable, a calibration of the camera 3 takes place. For this purpose, it is provided that the recorded view of the interior space 2 also captures fixed parts of the vehicle. These can be parts of the body or interior trim, such as the A-pillar 7, the B-pillar 8, or the center console 15.

The view moreover contains movable components of the vehicle interior space 2, the configuration of which is to be determined. These can be the seats of the vehicle, such as the driver seat 11, the front passenger seat 12, and rear seats 13, 14. The position and/or orientation of the seats 11, 12, 13, 14 can be changeable, including, for example, the inclination of the respective back rests. Movable components of the interior space 2 can also be accessory parts in the interior space 2, such as a foldable display 9 or a foldable table 10.

In a step S2, the image data are evaluated. The fixed parts and movable components are identified in the view. For example, with the aid of CAD data, the position and orientation of the camera 3 in the vehicle coordinate system can be determined in a simple manner on the basis of the fixed parts, such as the A-pillar 7, the B-pillar 8, or the center console 15. The configuration of the movable components, i.e. the seats 11, 12, 13, 14 or further components, such as the display 9 or the table 10, can then be identified from the view by further image evaluation, for example, by computer vision (i.e. machine viewing) or by simple image recognition (step S3).

Depending on the identified interior space configuration, various vehicle functions can then be actuated (step S4). In particular, specific airbags can be activated or deactivated.

While at least one exemplary embodiment was described above, it is to be noted that a large number of variations thereto exist. It is also to be noted that the described exemplary embodiments only represent nonlimiting examples, and it is not the intention to thus restrict the scope, the applicability, or the configuration of the devices and methods described here. Rather, the preceding description will provide a person skilled in the art with an instruction to implementing at least one exemplary embodiment, wherein it is obvious that various changes can be £ performed in the functionality and the £ arrangement of the elements described in an exemplary embodiment without deviating from the subject matter defined in each of the appended claims and its legal equivalents.

### LIST OF REFERENCE SIGNS

100 method for identifying a vehicle interior space configuration
1 vehicle
2 vehicle interior space
3 camera
4 interior mirror
5 processor
6 memory
7 fixed vehicle part (A-pillar)
8 fixed vehicle part (B-pillar)
9 foldable display
10 foldable table
11 driver seat
12 front passenger seat
13 left rear seat
14 right rear seat
15 center console

1.-15. (canceled)

16. A method for identifying a configuration of an interior space of a vehicle, the method comprising:
capturing image data using at least one image capture device, wherein the image data represents a view of the interior space of the vehicle, wherein the view at least partially contains at least one fixed part of the vehicle and at least one movable component of the interior space of the vehicle;
performing an evaluation of the image data, wherein the evaluation comprises:
identifying the at least one fixed part of the vehicle, in order to assign the view to a corresponding area of the interior space of the vehicle; and
identifying a configuration of the at least one movable component of the interior space in the area of the interior space of the vehicle that is assigned to the view.

17. The method as claimed in claim 16, wherein the configuration of the at least one movable component comprises an absolute position and an orientation of the movable component in the area of the interior space of the vehicle that is assigned to the view with respect to a three-dimensional coordinate system.

18. The method as claimed in claim 16, wherein the identified configuration of the at least one movable component comprises a relative position and orientation of the movable component with respect to at least one fixed part of the vehicle.

19. The method as claimed in claim 16, wherein the movable component comprises at least one seat of the vehicle, wherein identifying the configuration of the at least one movable component comprises identifying at least one of the group consisting of a seat position, seat rotation, and an inclination of a backrest of the seat.

20. The method as claimed in claim 16, wherein the movable component comprises at least one seat of the vehicle, wherein identifying the configuration of the at least one movable component comprises identifying a seat position, seat rotation, and an inclination of a backrest of the seat.

21. The method as claimed in claim 20, wherein, depending on the configuration of the at least one movable component, at least one signal source is actuated in order to prompt the signal source to output a defined signal depending on the actuation.

22. The method as claimed in claim 16, wherein the movable component comprises at least one accessory part of the vehicle, wherein identifying the configuration of the at least one movable component includes identifying at least a position or orientation of the accessory part in the interior space of the vehicle.

23. The method as claimed in claim 16, wherein a calibration of the image capture device is carried out at least in part using the identification of the at least one fixed part.

24. The method as claimed in claim 16, further comprising determining a position and/or orientation of the image capture device in the interior space of the vehicle using the identification of the at least one fixed part.

25. The method as claimed in claim 16, further comprising a comparison of the image data with design data of the vehicle.

26. The method as claimed in claim 16, wherein, depending on the configuration of the at least one movable component, at least one signal source is actuated in order to prompt the signal source to output a defined signal depending on the actuation.

27. The method as claimed in claim 16, wherein the view at least partially contains a plurality of movable components of the interior space of the vehicle, and wherein the method further comprises identifying a configuration of the plurality of movable components contained in the view.

28. A system for data processing, comprising:
at least one image capture device, attached in an interior space of a vehicle and is configured to capture image data, wherein the image data represents a view of the interior space of the vehicle, wherein the view at least partially contains at least one fixed part of the vehicle and at least one movable component of the interior space of the vehicle; and
at least one processor configured to perform an evaluation of the image data, wherein the evaluation comprises:
identifying the at least one fixed part of the vehicle, in order to assign the view to a corresponding area of the interior space of the vehicle; and
identifying a configuration of the at least one movable component of the interior space in the area of the interior space of the vehicle that is assigned to the view.

29. The system as claimed in claim 28, wherein the image capture device is arranged in a movable component of the interior space of the vehicle.

30. The system as claimed in claim 29, wherein the image capture device is arranged in an interior mirror of the vehicle.

31. The system as claimed in claim 30, wherein the image capture device is an infrared camera or a time-of-flight camera.

32. The system as claimed in claim 28, wherein the image capture device is an infrared camera or a time-of-flight camera.

33. A non-transitory computer readable medium having instructions which, when executed on a processing device, cause it to perform:
obtaining image data using at least one image capture device, wherein the image data represents a view of an interior space of a vehicle, wherein the view at least partially contains at least one fixed part of the vehicle and at least one movable component of the interior space of the vehicle; and
performing an evaluation of the image data, wherein the evaluation comprises:
identifying the at least one fixed part of the vehicle, in order to assign the view to a corresponding area of the interior space of the vehicle; and
identifying a configuration of the at least one movable component of the interior space in the area of the interior space of the vehicle that is assigned to the view.
